(19) United States
(12) Patent Application Publication
(10) Pub. No.: US 2015/0171395 A1
(43) Pub. Date: Jun. 18, 2015

(54) MODIFIED-CELLULOSE-NANOFIBER CONTAINING POLYETHYLENE FINE POROUS FILM, SEPARATOR, AND LITHIUM-ION BATTERY INCLUDING THE SAME

(71) Applicant: DIC Corporation, Tokyo (JP)

(72) Inventors: Takahito Ikuma, Sakura-shi (JP); Satoshi Katano, Sakura-shi (JP); Tetsuya Harada, Sakura-shi (JP)

(21) Appl. No.: 14/417,247

(22) PCT Filed: Jul. 16, 2013
(86) PCT No.: PCT/JP2013/069292

§ 371 Date: Jan. 26, 2015

(30) Foreign Application Priority Data
Jul. 27, 2012 (JP) 2012-167054

(51) Int. Cl. H01M 2/16; H01M 10/0525

(52) U.S. Cl. CPC H01M 2/1626; H01M 10/0525

(57) ABSTRACT

Provided are a modified-cellulose-nanofiber containing polyethylene fine porous film containing modified cellulose nanofibers having alkyl or alkenyl groups with 4 to 30 carbon atoms and a modified-cellulose-nanofiber containing polyethylene fine porous film containing modified cellulose nanofibers prepared by fibrillating cellulose into cellulose nanofibers in a nonaqueous resin and modifying the cellulose nanofibers. Also provided are a separator made of such a fine porous film and a lithium-ion battery including such a separator.

### TECHNICAL FIELD

The present invention relates to polyethylene fine porous films containing modified cellulose nanofibers, separators made of such fine porous films, and lithium-ion batteries including such separators.

### BACKGROUND ART

Polyethylene fine porous films are used in various applications for their functions. In particular, polyethylene fine porous films are considered promising separators for lithium-ion batteries for their shutdown function (see, for example, PTL 1). With the growing demand for polyethylene fine porous films in recent years, there has been a need for further improvement in their functions.

Separators for use in lithium-ion batteries require heat resistance, a reduced thickness, and strength as well as shutdown properties. To meet these requirements, various approaches have been attempted, including the addition of an inorganic filler, the use of ultra-high-molecular-weight polyethylene, coating with a heat-resistant layer, and the use of a multilayer separator. For example, PTL 2 discloses a separator including a laminate of polyethylene fibers and ultrafine fibers.

Unfortunately, several problems remain to be solved, including the complexity of manufacture and the difficulty in reducing the thickness.

### CITATION LIST

### Patent Literature

PTL 1: Japanese Unexamined Patent Application Publication No. 2009-270013

PTL 2: Japanese Unexamined Patent Application Publication No. 2006-278100

### SUMMARY OF INVENTION

### Technical Problem

An object of the present invention is to provide a single-layer polyethylene fine porous film that is easy to manufacture and that has good heat resistance, a separator made of such a fine porous film, and a lithium-ion battery including such a separator.

### Solution to Problem

After intensive research, the inventors have found that a modified-cellulose-nanofiber containing polyethylene fine porous film containing modified cellulose nanofibers prepared by introducing alkyl or alkenyl groups with 4 to 30 carbon atoms into cellulose or cellulose nanofibers serves as a single-layer thin film with good heat resistance.

### Advantageous Effects of Invention

By providing a modified-cellulose-nanofiber containing polyethylene fine porous film according to the present invention, there can be provided a single-layer thin separator with good heat resistance and a lithium-ion battery including such a separator.

### DESCRIPTION OF EMBODIMENTS

Embodiments of the present invention will now be described, although the following description is not intended to limit the present invention.

A modified-cellulose-nanofiber containing polyethylene fine porous film according to the present invention contains modified cellulose nanofibers and polyethylene.

The polyethylene resin is a polymeric compound used in common molding processes such as extrusion molding, injection molding, inflation molding, and blow molding. The polyethylene resin has a structure formed by the polymerization of ethylene. Examples of polyethylene resins include low-density polyethylene, linear low-density polyethylene, medium-density polyethylene, high-density polyethylene, and ultra-high-molecular-weight polyethylene, which may be used alone or in a mixture. In view of the strength of the fine porous film, the polyethylene resin is preferably high-density polyethylene.

The polyethylene resin preferably has a viscosity average molecular weight of 10,000 to less than 10,000,000. A polyethylene resin having a viscosity average molecular weight of 10,000 or more is preferred because it readily forms a fine porous film with high strength. A polyethylene resin having a viscosity average molecular weight of less than 10,000,000 is preferred because it tends to provide good sheet formability, particularly good thickness stability. A more preferred range of viscosity is 10,000 to less than 5,000,000. In the present invention, either a single type of polyethylene or a mixture of different types of polyethylene may be used.

In addition to the polyethylene resin, the fine porous film may contain polyolefin resins other than polyethylene resins.

Examples of polyolefin resins other than polyethylene resins include homopolymers of olefins such as propylene, 1-butene, 4-methyl-1-pentene, 1-hexene, and 1-octene and copolymers or block copolymers of olefins such as ethylene, propylene, 1-butene, 4-methyl-1-pentene, 1-hexene, and 1-octene, specifically, isotactic polypropylene, atactic polypropylene, polybutene, and ethylene-propylene rubber.

If the fine porous film contains polyolefin resins other than polyethylene resins, they are preferably present in an amount of less than 50%. A content of polyolefin resins other than polyethylene resins of 50% or more is undesirable because it results in degraded shutdown properties.

### [Modified Cellulose Nanofibers]

The modified cellulose nanofibers in the present invention are modified cellulose nanofibers having alkyl or alkenyl groups with 4 to 30 carbon atoms on cellulose or cellulose nanofibers.

The modified cellulose nanofibers having alkyl or alkenyl groups with 4 to 30 carbon atoms can be prepared by reacting the hydroxyl groups of cellulose nanofibers with at least one compound selected from saturated fatty acid chlorides having 5 to 31 carbon atoms, unsaturated fatty acid chlorides having 5 to 31 carbon atoms, and compounds having an alkyl or alkenyl group with 4 to 30 carbon atoms and a maleic anhydride backbone to introduce modifier groups having an alkyl or alkenyl group with 4 to 30 carbon atoms.

Alternatively, the modified cellulose nanofibers having alkyl or alkenyl groups with 4 to 30 carbon atoms can be prepared by reacting cellulose or pulp with at least one compound selected from saturated fatty acid chlorides having 5 to 31 carbon atoms, unsaturated fatty acid chlorides having 5 to 31 carbon atoms, and compounds having an alkyl or alkenyl group with 4 to 30 carbon atoms and a maleic anhydride backbone to prepare modified cellulose or pulp having introduced therein modifier groups having an alkyl or alkenyl group with 4 to 30 carbon atoms and then fibrillating the modified cellulose or pulp into nanofibers.

Any cellulose that can be used as a pulverized material may be used. Examples of celluloses include pulp, cotton, paper, regenerated cellulose fibers (e.g., rayon, cupra, polynosic, and acetate), bacterial cellulose, and animal-derived celluloses such as those from sea squirts.

A cellulose powder prepared by crushing a cellulose material to a certain particle size distribution may also be as a pulverized material. Examples of cellulose powders include KC FLOCK available from Nippon Paper Chemicals Co., Ltd., CEOLUS available from Asahi Kasei Chemicals Corporation, and AVICEL available from FMC Corporation.

Suitable pulps include both wood pulps and non-wood pulps. Examples of wood pulps include mechanical pulps and chemical pulps, of which chemical pulps are preferred for their low lignin content. Examples of chemical pulps include sulfide pulp, craft pulp, and alkali pulp, all of which are suitable. Examples of non-wood pulps include straw, bagasse, kenaf, bamboo, reed, paper mulberry, and flax, all of which can be used.

Cotton is a plant mainly used as clothing fibers. Raw cotton, cotton fiber, and cotton fabric can all be used.

Paper is made of fibers separated from pulp. Used paper is also suitable, including newspaper, waste milk packages, and used copy paper.

### [Cellulose Nanofibers]

The cellulose nanofibers can be prepared by pulverizing cellulose or pulp. Cellulose or pulp may be pulverized by a method known and used in the art. Typically, the cellulose nanofibers can be manufactured by fibrillating or pulverizing cellulose or pulp in water or an aqueous medium by grinding and/or beating using devices such as refiners, high-pressure homogenizers, media-stirring mills, stone mills, grinders, twin-screw extruders, and bead mills. Alternatively, the cellulose nanofibers can be manufactured by a known method such as that disclosed in Japanese Unexamined Patent Application Publication No. 2005-42283. The cellulose nanofibers can also be manufactured using microorganisms (e.g., acetic acid bacteria (Acetobacter)). The cellulose nanofibers can also be prepared by fibrillating cellulose or pulp in a resin for fibrillation without using water or an aqueous medium.

The average fiber diameter of the cellulose nanofibers is preferably 4 to 800 nm, more preferably 4 to 400 nm, even more preferably 4 to 100 nm. The fiber length of the cellulose nanofibers is significantly larger than the fiber diameter. Although the fiber length is difficult to determine, the average fiber length is preferably 5 times or more, more preferably 10 times or more, even more preferably 20 times or more, the fiber diameter. Specifically, the average fiber length is preferably 50 nm to 200 μm, more preferably 100 nm to 50 μm.

An example method for fibrillating cellulose or pulp in a resin for fibrillation without using water or an aqueous medium includes adding cellulose or pulp to a resin for fibrillation and then applying a mechanical shear. The shear can be applied, for example, using known mixers such as bead mills, ultrasonic homogenizers, extruders such as single-screw extruders and twin-screw extruders, Banbury mixers, grinders, pressure kneaders, and two-roll mills. Preferred among these mixers are pressure kneaders, which produce a stable shear even in a viscous resin.

### [Resin for Fibrillation]

The resin for fibrillation may be a resin known and used in the art that does not interfere with the advantageous effects of the present invention, for example, a polyester resin (A), a vinyl resin (B), or a modified epoxy resin (C). These resins may be used alone or in a mixture of two or more.

### [Polyester Resin (A)]

The polyester resin (A) is a polyester resin prepared by reacting at least one polyol represented by general formula (2):

A-(OH)ₘ (2)

(where A is an aliphatic hydrocarbon group having 1 to 20 carbon atoms and optionally interrupted by oxygen or an optionally substituted aromatic group or heterocyclic aromatic group, and m is an integer of 2 to 4) with at least one polycarboxylic acid represented by general formula (3):

B—(COOH)ₙ (3)

(where B is an aliphatic hydrocarbon group having 1 to 20 carbon atoms or an optionally substituted aromatic group or heterocyclic aromatic group, and n is an integer of 2 to 4).

Examples of polyols represented by general formula (2) include ethylene glycol, propylene glycol, 1,3-butanediol, 1,4-butanediol, pentyl glycol, neopentyl glycol, 1,5-pentanediol, 1,6-hexanediol, 1,7-heptanediol, 1,8-octanediol, 1,9-nonanediol, 1,10-decanediol, 1,11-undecanediol, 1,12-dodecanediol, diethylene glycol, triethylene glycol, tetraethylene glycol, polyethylene glycol, dipropylene glycol, polypropylene glycol, 2-methyl-1,3-propanediol, 2-butyl-2-ethyl-1,3-propanediol, 2-methyl-1,4-butanediol, 2-ethyl-1,4-butanediol, 2-methyl-1,3-propanediol, 3-methyl-1,5-pentanediol, 3-methyl-1,5-heptanediol, hydrogenated bisphenol A, adducts of bisphenol A with propylene oxide or ethylene oxide, 1,2,3,4-tetrahydroxybutane, glycerol, trimethylolpropane, 1,3-propanediol, 1,2-cyclohexane glycol, 1,3-cyclohexane glycol, 1,4-cyclohexane glycol, 1,4-cyclohexanedimethanol, p-xylene glycol, bicyclohexyl-4,4′-diol, 2,6-decalin glycol, 2,7-decalin glycol, ethylene glycol carbonate, glycerol, trimethylolpropane, and pentaerythritol.

Examples of polycarboxylic acids represented by general formula (3) include unsaturated dibasic acids and anhydrides thereof and saturated dibasic acids and anhydrides thereof. Examples of unsaturated dibasic acids and anhydrides thereof include maleic acid, maleic anhydride, fumaric acid, itaconic acid, citraconic acid, chloromaleic acid, and esters thereof. Other examples include halogenated maleic anhydrides, α,β-unsaturated dibasic acids such as aconitic acid, and β,γ-unsaturated dibasic acids such as dihydromuconic acid. Examples of saturated dibasic acids and anhydrides thereof include phthalic acid, phthalic anhydride, halogenated phthalic anhydrides, isophthalic acid, terephthalic acid, nitrophthalic acid, tetrahydrophthalic acid, tetrahydrophthalic anhydride, endomethylenetetrahydrophthalic anhydride, halogenated phthalic anhydrides, and esters thereof. Other examples include hexahydrophthalic acid, hexahydrophthalic anhydride, hexahydroterephthalic acid, hexahydroisophthalic acid, 1,4-cyclohexanedicarboxylic acid, 1,3-cyclohexanedicarboxylic acid, methylhexahydrophthalic acid, HET acid, 1,1-cyclobutanedicarboxylic acid, oxalic acid, succinic acid, succinic anhydride, malonic acid, glutaric acid, adipic acid, azelaic acid, pimelic acid, suberic acid, azelaic acid, sebacic acid, 1,12-dodecanedioic acid, 2,6-naphthalenedicarboxylic acid, 2,7-naphthalenedicarboxylic acid, 2,3-naphthalenedicarboxylic acid, 2,3-naphthalenedicarboxylic anhydride, 4,4′-biphenyldicarboxylic acid, and dialkyl esters thereof.

These polyols and polycarboxylic acids may be used in combination with monohydric alcohols, monovalent carboxylic acids, and hydroxycarboxylic acids that do not substantially interfere with the properties thereof.

Examples of monohydric alcohols include methanol, ethanol, propanol, isopropanol, butanol, isobutanol, 2-butanol, 3-butanol, n-amyl alcohol, n-hexanol, isohexanol, n-heptanol, isoheptanol, n-octanol, 2-ethylhexanol, isooctanol, n-nonanol, isononanol, n-decanol, isodecanol, isoundecanol, lauryl alcohol, cetyl alcohol, decyl alcohol, undecyl alcohol, tridecyl alcohol, benzyl alcohol, and stearyl alcohol, which may be used alone or in combination.

Examples of monovalent carboxylic acids include benzoic acid, heptanoic acid, nonanoic acid, caprylic acid, nonanoic acid, capric acid, undecylic acid, and lauric acid, which may be used alone or in combination.

Examples of hydroxycarboxylic acids include lactic acid, glycolic acid, 2-hydroxy-n-butyric acid, 2-hydroxycaproic acid, 2-hydroxy-3,3-dimethylbutyric acid, 2-hydroxy-3-methylbutyric acid, 2-hydroxyisocaproic acid, and p-hydroxybenzoic acid, which may be used alone or in combination.

The polyester resin (A) may be a modified polyester resin prepared by modifying a polyester resin. Examples of modified polyester resins include urethane-modified polyesters, acrylic-modified polyesters, epoxy-modified polyesters, and silicone-modified polyesters.

The polyester resin (A) may be either a linear polyester or a branched polyester.

The polyester resin (A) preferably has an ester group concentration of 6.0 mmol/g or more, more preferably 6.0 to 14 mmol/g, even more preferably 6.0 to 20 mmol/g, particularly preferably 6.0 to 30 mmol/g.

The polyester resin (A) preferably has an ester group concentration of 6.0 mmol/g or more and an acid value of 10 mg KOH/g or more.

More preferably, the polyester resin (A) has an acid value of 10 to 100 mg KOH/g, even more preferably 10 to 200 mg KOH/g, particularly preferably 10 to 300 mg KOH/g.

The polyester resin (A) preferably has an ester group concentration of 6.0 mmol/g or more and a hydroxyl value of 10 or more.

More preferably, the polyester resin (A) has a hydroxyl value of 10 to 500 mg KOH/g, even more preferably 10 to 800 mg KOH/g, particularly preferably 10 to 1,000 mg KOH/g.

In particular, the polyester resin preferably has an ester group concentration of 6.0 mmol/g or more, an acid value of 10 mg KOH/g or more, and a hydroxyl value of 10 mg KOH/g or more.

In the present invention, such polyester resins (A) as described above may be used alone or in combination.

### [Vinyl Resin (B)]

The vinyl resin (B) is a polymer or copolymer of a vinyl monomer. Examples of suitable vinyl monomers include, but not limited to, (meth)acrylic acid esters, vinyl esters, maleic acid diesters, (meth)acrylamides, styrenes, vinyl ethers, vinyl ketones, olefins, maleimides, and (meth)acrylonitrile. Among preferred vinyl resins (B) are (meth)acrylic resins prepared by polymerizing (meth)acrylic acid esters.

Preferred examples of vinyl monomers will now be described. Examples of (meth)acrylic acid esters include methyl (meth)acrylate, ethyl (meth)acrylate, n-propyl(meth)acrylate, isopropyl(meth)acrylate, n-butyl (meth)acrylate, isobutyl (meth)acrylate, t-butyl (meth)acrylate, amyl(meth)acrylate, n-hexyl(meth)acrylate, cyclohexyl(meth)acrylate, t-butylcyclohexyl(meth)acrylate, 2-ethylhexyl(meth)acrylate, t-octyl(meth)acrylate, dodecyl(meth)acrylate, octadecyl(meth)acrylate, acetoxyethyl (meth)acrylate, phenyl(meth)acrylate, 2-hydroxyethyl (meth)acrylate, 2-hydroxypropyl(meth)acrylate, 3-hydroxypropyl(meth)acrylate, 4-hydroxybutyl (meth)acrylate, 2-methoxyethyl (meth)acrylate, 2-ethoxyethyl (meth)acrylate, 2-(2-methoxyethoxyl)ethyl (meth)acrylate, 3-phenoxy-2-hydroxypropyl(meth)acrylate, 2-chloroethyl (meth)acrylate, glycidyl(meth)acrylate, 3,4-epoxycyclohexylmethyl (meth)acrylate, vinyl(meth)acrylate, 2-phenylvinyl(meth)acrylate, 1-propenyl(meth)acrylate, allyl(meth)acrylate, 2-allyloxyethyl (meth)acrylate, propargyl(meth)acrylate, benzyl (meth)acrylate, diethylene glycol monomethyl ether(meth)acrylate, diethylene glycol monoethyl ether(meth)acrylate, triethylene glycol monomethyl ether(meth)acrylate, triethylene glycol monoethyl ether(meth)acrylate, polyethylene glycol monomethyl ether(meth)acrylate, polyethylene glycol monoethyl ether (meth)acrylate, β-phenoxyethoxyethyl (meth)acrylate, nonylphenoxypolyethylene glycol(meth)acrylate, dicyclopentenyl(meth)acrylate, dicyclopentenyloxyethyl (meth)acrylate, trifluoroethyl (meth)acrylate, octafluoropentyl(meth)acrylate, perfluorooctylethyl (meth)acrylate, dicyclopentanyl(meth)acrylate, tribromophenyl(meth)acrylate, tribromophenyloxyethyl (meth)acrylate, and γ-butyrolactone(meth)acrylate.

Examples of vinyl esters include vinyl acetate, vinyl chloroacetate, vinyl propionate, vinyl butyrate, vinyl methoxyacetate, and vinyl benzoate.

Examples of maleic acid diesters include dimethyl maleate, diethyl maleate, and dibutyl maleate.

Examples of fumaric acid diesters include dimethyl fumarate, diethyl fumarate, and dibutyl fumarate.

Examples of itaconic acid diesters include dimethyl itaconate, diethyl itaconate, and dibutyl itaconate.

Examples of (meth)acrylamides include (meth)acrylamide, N-methyl(meth)acrylamide, N-ethyl(meth)acrylamide, N-propyl(meth)acrylamide, N-isopropyl(meth)acrylamide, N-n-butyl(meth)acrylamide, N-t-butyl(meth)acrylamide, N-cyclohexyl(meth)acrylamide, N-(2-methoxyethyl)(meth)acrylamide, N,N-dimethyl(meth)acrylamide, N,N-diethyl(meth)acrylamide, N-phenyl(meth)acrylamide, N-nitrophenylacrylamide, N-ethyl-N-phenylacrylamide, N-benzyl(meth)acrylamide, (meth)acryloylmorpholine, diacetoneacrylamide, N-methylolacrylamide, N-hydroxyethylacrylamide, vinyl(meth)acrylamide, N,N-diallyl(meth)acrylamide, and N-allyl(meth)acrylamide.

Examples of styrenes include styrene, methylstyrene, dimethylstyrene, trimethylstyrene, ethylstyrene, isopropylstyrene, butyl styrene, hydroxystyrene, methoxystyrene, butoxystyrene, acetoxystyrene, chlorostyrene, dichlorostyrene, bromostyrene, chloromethylstyrene, and α-methylstyrene.

Examples of vinyl ethers include methyl vinyl ether, ethyl vinyl ether, 2-chloroethyl vinyl ether, hydroxyethyl vinyl ether, propyl vinyl ether, butyl vinyl ether, hexyl vinyl ether, octyl vinyl ether, methoxyethyl vinyl ether, and phenyl vinyl ether.

Examples of vinyl ketones include methyl vinyl ketone, ethyl vinyl ketone, propyl vinyl ketone, and phenyl vinyl ketone.

Examples of olefins include ethylene, propylene, isobutylene, butadiene, and isoprene.

Examples of maleimides include maleimide, butylmaleimide, cyclohexylmaleimide, and phenylmaleimide.

Other examples include (meth)acrylonitrile, vinyl-substituted heterocyclic groups (e.g., vinylpyridine, N-vinylpyrrolidone, and vinylcarbazole), N-vinylformamide, N-vinylacetamide, N-vinylimidazole, and vinylcaprolactone.

### [Functional Group]

The vinyl resin (B) preferably has a functional group. This functional group interacts with a diluent resin to improve the physical properties, such as mechanical properties, of a molded product. Examples of such functional groups include halogens (e.g., fluorine and chlorine), hydroxyl, carboxyl, amino, silanol, and cyano. The vinyl resin (B) may have different functional groups.

The vinyl resin (B) can be prepared by heating a vinyl monomer in a reaction vessel in the presence of a polymerization initiator, optionally followed by aging. The reaction is performed, for example, at a reaction temperature of 30° C. to 150° C., preferably 60° C. to 120° C., depending on the polymerization initiator and the solvent. The polymerization may be performed in the presence of a nonreactive solvent.

Examples of polymerization initiators include peroxides such as t-butyl peroxybenzoate, di-t-butyl peroxide, cumene perhydroxide, acetyl peroxide, benzoyl peroxide, and lauroyl peroxide; and azo compounds such as azobisisobutyronitrile, azobis-2,4-dimethylvaleronitrile, and azobiscyclohexanecarbonitrile.

Examples of nonreactive solvents include aliphatic hydrocarbon solvents such as hexane and mineral spirit; aromatic hydrocarbon solvents such as benzene, toluene, and xylene; ester solvents such as butyl acetate; alcohol solvents such as methanol and butanol; and aprotic polar solvents such as dimethylformamide, dimethyl sulfoxide, and N-methylpyrrolidone. These solvents may be used alone or in combination.

In the present invention, such vinyl resins (B) as described above may be used alone or in combination.

The vinyl resin (B) may be either a linear polymer or a branched polymer. If the vinyl resin (B) is a branched polymer, it may be comb-shaped or star-shaped.

### [Molecular Weight]

The vinyl resin (B) preferably has a number average molecular weight of 3,000 or less. Although the mechanism is not fully understood, it is believed that a vinyl resin having a number average molecular weight of 3,000 or less has a higher affinity for cellulose fibers.

### [Acid Value]

If the vinyl resin (B) has a number average molecular weight of 3,000 or less, it preferably has an acid value of 30 to less than 60 mg KOH/g.

### [Hydroxyl Value]

If the vinyl resin (B) has a number average molecular weight of 3,000 or less, it preferably has a hydroxyl value of 30 mg KOH/g or more, more preferably 50 mg KOH/g or more.

In particular, if the vinyl resin (B) has a number average molecular weight of 3,000 or less, it preferably has an acid value of 30 to less than 60 mg KOH/g and a hydroxyl value of 30 mg KOH/g or more.

### [Modified Epoxy Resin (C)]

The modified epoxy resin (C) is a modified epoxy resin having epoxy groups and having a hydroxyl value of 100 mg KOH/g or more.

The modified epoxy resin (C) can be prepared by reacting an epoxy resin (D) with a compound (E) having a carboxyl or amino group.

### [Epoxy Resin (D)]

The epoxy resin (D) is a compound having epoxy groups in the molecule thereof. The epoxy resin (D) may be any epoxy resin, e.g., of any structure, that reacts with the compound (E) having a carboxyl or amino group, described later, to form a modified epoxy resin (C) having a hydroxyl value of 100 mg KOH/g or more. Examples of such epoxy resins include polyvalent epoxy resins and monovalent epoxy resins. Examples of polyvalent epoxy resins include bisphenol A epoxy resins, bisphenol F epoxy resins, bisphenol AD epoxy resins, bisphenol S epoxy resins, phenol novolac epoxy resins, cresol novolac epoxy resins, p-tert-butylphenol novolac epoxy resins, nonylphenol novolac epoxy resins, and t-butylcatechol epoxy resins. Examples of monovalent epoxy resins include condensates of epihalohydrins with aliphatic alcohols such as butanol, aliphatic alcohols having 11 or 12 carbon atoms, and monohydric phenols such as phenol, p-ethylphenol, o-cresol, m-cresol, p-cresol, p-t-butylphenol, s-butylphenol, nonylphenol, and xylenol; and condensates of epihalohydrins with monovalent carboxyl groups such as neodecanoic acid. Other examples include glycidylamines such as condensates of epihalohydrins with diaminodiphenylmethane; polyvalent aliphatic epoxy resins such as polyglycidyl ethers from vegetable oils such as soybean oil and castor oil; polyvalent alkylene glycol epoxy resins such as condensates of epihalohydrins with ethylene glycol, propylene glycol, 1,4-butanediol, 1,6-hexanediol, glycerol, erythritol, polyethylene glycol, polypropylene glycol, polytetramethylene ether glycol, and trimethylolpropane; and water-based epoxy resins disclosed in Japanese Unexamined Patent Application Publication No. 2005-239928. These may be used alone or in combination.

The epoxy resin (D) may optionally be liquefied or thinned, for example, with an organic solvent or nonreactive diluent.

### [Compound (E) Having Carboxyl or Amino Group]

The compound (E) having a carboxyl or amino group in the present invention may be any compound that reacts with the epoxy resin (D) to form a modified epoxy resin (C) having a hydroxyl value of 100 mg KOH/g or more. Specifically, one or more of a compound (E1) having a carboxyl group, a compound (E2) having an amino group, and a compound (E3) having carboxyl and amino groups may be used.

A preferred compound (E) having a carboxyl or amino group is a compound (E4) having a carboxyl or amino group and a hydroxyl group, which reacts with the epoxy compound (D) to form a modified epoxy resin (C) with a high hydroxyl value.

### [Compound (E1) Having Carboxyl Group]

The compound (E1) having a carboxyl group in the present invention is a compound having one or more carboxyl groups. Examples of compounds having one carboxyl group include aliphatic acids such as formic acid, acetic acid, propionic acid, butanoic acid, pentanoic acid, hexanoic acid, heptanoic acid, octanoic acid, nonanoic acid, decanoic acid, chloroacetic acid, trifluoroacetic acid, isopropanoic acid, isostearic acid, and neodecanoic acid; and aromatic carboxylic acids such as benzoic acid, methylbenzoic acid, dimethylbenzoic acid, trimethylbenzoic acid, phenylacetic acid, 4-isopropylbenzoic acid, 2-phenylpropanoic acid, 2-phenylacrylic acid, 3-phenylpropanoic acid, and cinnamic acid. Examples of compounds having two or more carboxyl groups include carboxylic acids such as succinic acid, adipic acid, terephthalic acid, isophthalic acid, and pyromellitic acid, and anhydrides thereof. Other examples include maleic acid, maleic anhydride, fumaric acid, itaconic acid, citraconic acid, chloromaleic acid, and esters thereof. Still other examples include halogenated maleic anhydrides, α,β-unsaturated dibasic acids such as aconitic acid, and β,γ-unsaturated dibasic acids such as dihydromuconic acid. Examples of saturated dibasic acids and anhydrides thereof include phthalic acid, phthalic anhydride, halogenated phthalic anhydrides, isophthalic acid, terephthalic acid, nitrophthalic acid, tetrahydrophthalic acid, tetrahydrophthalic anhydride, endomethylenetetrahydrophthalic anhydride, halogenated phthalic anhydrides, and esters thereof. Other examples include hexahydrophthalic acid, hexahydrophthalic anhydride, hexahydroterephthalic acid, hexahydroisophthalic acid, 1,4-cyclohexanedicarboxylic acid, 1,3-cyclohexanedicarboxylic acid, methylhexahydrophthalic acid, HET acid, 1,1-cyclobutanedicarboxylic acid, oxalic acid, succinic acid, succinic anhydride, malonic acid, glutaric acid, adipic acid, azelaic acid, pimelic acid, suberic acid, azelaic acid, sebacic acid, 1,12-dodecanedioic acid, 2,6-naphthalenedicarboxylic acid, 2,7-naphthalenedicarboxylic acid, 2,3-naphthalenedicarboxylic acid, 2,3-naphthalenedicarboxylic anhydride, and 4,4′-biphenyldicarboxylic acid.

### [Compound (E2) Having Amino Group]

The compound (E2) having an amino group in the present invention is a compound having one or more amino groups. Examples of compounds having one amino group include methylamine, ethylamine, dimethylamine, diethylamine, propylamine, butylamine, N,N-dimethyl-2-propaneamine, aniline, toluidine, and 2-aminoanthracene. Examples of compounds having two or more amino groups include ethylenediamine, 1,3-propanediamine, 1,4-butanediamine, 1,6-hexamethylenediamine, 1,4-cyclohexanediamine, 3-aminomethyl-3,5,5-trimethylcyclohexylamine, piperazine, 2,5-dimethylpiperazine, isophoronediamine, 4,4′-cyclohexylmethanediamine, norbornanediamine, hydrazine, diethylenetriamine, triethylenetriamine, 1,3-bis(aminomethyl)cyclohexane, and xylylenediamine.

### [Compound (E3) Having Carboxyl and Amino Groups]

The compound (E3) having carboxyl and amino groups in the present invention is a compound having one or more carboxyl groups and one or more amino groups. Typically, the compound (E3) having carboxyl and amino groups is an amino acid. The amino acid may have a hydroxyl group. Examples of amino acids include alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, aminobutyric acid, theanine, tricholomic acid, and kainic acid.

### [Compound (E4) Having Carboxyl or Amino Group and Hydroxyl Group]

The compound (E4) having a carboxyl or amino group and a hydroxyl group is a compound having a carboxyl or amino group and one or more hydroxyl groups. Examples of such compounds include glycolic acid, glyceric acid, hydroxypropionic acid, hydroxybutyric acid, malic acid, 2,3-dihydroxybutanedioic acid, citric acid, isocitric acid, mevalonic acid, pantoic acid, ricinoleic acid, dimethylolpropionic acid, dimethylolbutanoic acid, hydroxyphenylpropanoic acid, mandelic acid, benzilic acid, hydroxymethylamine, hydroxyethylamine, and hydroxypropylamine.

The modified epoxy resin (C) preferably has 0.3 or more epoxy groups, more preferably 0.5 or more epoxy groups, most preferably 1 or more epoxy groups, per molecule.

In the manufacture of the modified epoxy resin (C), the epoxy resin (D) and the compound (E) having a carboxyl or amino group may be reacted with or without a solvent. Preferably, the epoxy resin (D) and the compound (E) having a carboxyl or amino group are reacted without a solvent. This eliminates the need to remove a solvent.

Any solvent may be used for polymerization. Examples of solvents include methanol, ethanol, isopropanol, 1-butanol, t-butanol, isobutanol, diacetone alcohol, acetone, methyl ethyl ketone, diethyl ketone, methyl isobutyl ketone, cyclohexanone, dibutyl ether, tetrahydrofuran, dioxane, ethylene glycol monomethyl ether, diethylene glycol monomethyl ether, diethylene glycol monoethyl ether, diethylene glycol diethyl ether, butyl cellosolve, toluene, xylene, ethyl acetate, and isobutyl acetate. These solvents may be used alone or in a mixture.

Reaction catalysts such as Lewis acid catalysts and Lewis base catalysts may also be used.

Examples of reaction catalysts include boron trifluoride, benzyltrimethylammonium chloride, dimethylaminopyridine, pyridine, 8-diazabicyclo[5.4.0]undeca-7-ene, and triphenylphosphine.

The reaction temperature is preferably room temperature to 200° C.

### [Proportion Between Resin for Fibrillation and Cellulose]

Although the resin for fibrillation and the cellulose or pulp may be mixed in any proportion in the present invention, an insufficient or excessive proportion of the resin for fibrillation does not allow the cellulose or pulp to be sufficiently pulverized. The proportion of the cellulose or pulp in the composition containing the cellulose and the resin for fibrillation may be 10% to 90% by mass, preferably 30% to 80% by mass, more preferably 40% to 70% by mass.

The cellulose nanofibers or the cellulose or pulp may be reacted with at least one compound selected from saturated fatty acid chlorides having 5 to 31 carbon atoms, unsaturated fatty acid chlorides having 5 to 31 carbon atoms, and compounds having an alkyl or alkenyl group with 4 to 30 carbon atoms and a maleic anhydride backbone by a method known and used in the art. For example, the reaction may be performed by dispersing the cellulose nanofibers or the cellulose or pulp in an aprotic polar solvent, dehydrating the cellulose nanofibers or the cellulose or pulp, and adding a saturated fatty acid chloride having 5 to 31 carbon atoms or an unsaturated fatty acid chloride having 5 to 31 carbon atoms. This reaction may be performed in the presence of a catalyst.

Examples of saturated fatty acid chlorides having 5 to 31 carbon atoms include heptanoyl chloride, heptanoyl bromide, isoheptanoyl chloride, isoheptanoyl bromide, hexanoyl chloride, hexanoyl bromide, 2-methylpentanoyl chloride, 2-methylpentanoyl bromide, heptanoyl chloride, heptanoyl bromide, octanoyl chloride, octanoyl bromide, nonanoyl chloride, nonanoyl bromide, decanoyl chloride, decanoyl bromide, undecanoyl chloride, undecanoyl bromide, dodecanoyl chloride, dodecanoyl bromide, tetradecanoyl chloride, tetradecanoyl bromide, hexadecanoyl chloride, hexadecanoyl bromide, octadecanoyl chloride, octadecanoyl bromide, tetracosanoyl chloride, and tetracosanoyl bromide.

Examples of unsaturated fatty acid chlorides having 5 to 31 carbon atoms include crotonoyl chloride, crotonoyl bromide, myristoleoyl chloride, myristoleoyl bromide, palmitoleoyl chloride, palmitoleoyl bromide, oleoyl chloride, oleoyl bromide, linoleoyl chloride, linoleoyl bromide, linolenoyl chloride, and linolenoyl bromide.

Examples of compounds having an alkyl or alkenyl group with 4 to 30 carbon atoms and a maleic anhydride backbone include alkylsuccinic anhydrides such as octylsuccinic anhydride, dodecylsuccinic anhydride, hexadecylsuccinic anhydride, and octadecylsuccinic anhydride; and alkenylsuccinic anhydrides such as pentenylsuccinic anhydride, hexenylsuccinic anhydride, octenylsuccinic anhydride, decenylsuccinic anhydride, undecenylsuccinic anhydride, dodecenylsuccinic anhydride, tridecenylsuccinic anhydride, hexadecenylsuccinic anhydride, and octadecenylsuccinic anhydride.

Examples of aprotic polar solvents include N-methylpyrrolidone, dimethylformamide, dimethylacetamide, dimethyl sulfoxide, and acetonitrile.

The dehydration may be performed by a method known and used in the art. For example, the dehydration may be performed by repeating the steps of dispersing the cellulose nanofibers or the cellulose or pulp in an aprotic polar solvent, causing the cellulose nanofibers or the cellulose or pulp to settle using a centrifuge, removing the aqueous supernatant, and dispersing again the settled cellulose nanofibers or cellulose or pulp in an aprotic polar solvent.

Alternatively, the dehydration may be performed by dispersing the cellulose nanofibers or the cellulose or pulp in an aprotic polar solvent having a boiling point of 150° C. or higher and distilling the dispersion.

Examples of catalysts include basic catalysts such as pyridine, N,N-dimethylaminopyridine, triethylamine, sodium hydrogen, tert-butyllithium, lithium diisopropylamide, potassium tert-butoxide, sodium methoxide, sodium ethoxide, sodium hydroxide, and sodium acetate.

The reaction may be performed at any temperature for any period of time depending on the reactivity of the at least one compound selected from saturated fatty acid chlorides having 5 to 31 carbon atoms, unsaturated fatty acid chlorides having 5 to 31 carbon atoms, and compounds having an alkyl or alkenyl group with 4 to 30 carbon atoms and a maleic anhydride backbone, and on the degree of ester substitution (D.S.) of the target compound.

As used herein, the term “degree of substitution (D.S.)” refers to the number of hydroxyl groups modified by the at least one compound selected from saturated fatty acid chlorides having 5 to 31 carbon atoms, unsaturated fatty acid chlorides having 5 to 31 carbon atoms, and compounds having an alkyl or alkenyl group with 4 to 30 carbon atoms and a maleic anhydride backbone, per glucose unit in the modified cellulose nanofibers or the modified cellulose or pulp.

The degree of substitution (D.S.) can be determined by methods such as elemental analysis and NMR. If the modified cellulose nanofibers or the modified cellulose or pulp is manufactured using only one compound selected from saturated fatty acid chlorides having 5 to 31 carbon atoms, unsaturated fatty acid chlorides having 5 to 31 carbon atoms, and compounds having an alkyl or alkenyl group with 4 to 30 carbon atoms and a maleic anhydride backbone, the degree of substitution (D.S.) can be determined by back titration.

Back titration is performed as follows.

Into a 100 mL conical flask is accurately weighed about 0.5 g of dry modified cellulose nanofibers or modified cellulose or pulp.

To the flask are added 5 mL of ethanol and 5 mL of distilled water, and the mixture is stirred at room temperature for 30 minutes. To the flask is added 10 mL of 0.5 N sodium hydroxide solution, and a condenser is attached to the conical flask. The mixture is stirred in a hot water bath at 80° C. for 60 minutes to hydrolyze ester bonds between cellulose and modifier groups having an alkyl or alkenyl group with 4 to 30 carbon atoms, followed by cooling to room temperature with stirring.

To the resulting mixture are added a few drops of a 85% solution of phenolphthalein in ethanol, and it is back-titrated with 0.1 N aqueous hydrochloric acid solution.

The degree of substitution (DS) of the modified cellulose nanofibers is calculated by the following equation:

DS=X/((Y−Z×(M−18))/162)

where

X is the number of moles of the acid generated from the modifier groups having an alkyl or alkenyl group with 4 to 30 carbon atoms during hydrolysis as calculated by the following equation:

X=(0.5×10−0.1*Y)/L

Y is the volume (mL) of 0.1 N aqueous hydrochloric acid solution required for back titration;

L is the valence of the acid generated from the modifier groups having an alkyl or alkenyl group with 4 to 30 carbon atoms during hydrolysis;

M is the molecular weight of the acid (unneutralized) generated from the modifier groups having an alkyl or alkenyl group with 4 to 30 carbon atoms during hydrolysis; and

Z is the weight of the accurately weighed modified cellulose nanofibers or modified cellulose or pulp.

After the reaction is complete, the modified cellulose nanofibers or modified cellulose or pulp is preferably washed by filtration to remove any unreacted compound and catalyst. The solvent used for washing is preferably a low-boiling-point solvent, which is very easy to remove. Examples of low-boiling-point solvents include acetone, methanol, ethanol, isopropyl alcohol, and 2-butanone.

To react cellulose nanofibers prepared by pulverizing cellulose in a resin for fibrillation with at least one compound selected from saturated fatty acid chlorides having 5 to 31 carbon atoms, unsaturated fatty acid chlorides having 5 to 31 carbon atoms, and compounds having an alkyl or alkenyl group with 4 to 30 carbon atoms and a maleic anhydride backbone, the at least one compound selected from saturated fatty acid chlorides having 5 to 31 carbon atoms, unsaturated fatty acid chlorides having 5 to 31 carbon atoms, and compounds having an alkyl or alkenyl group with 4 to 30 carbon atoms and a maleic anhydride backbone may be added to a mixture of the resin for fibrillation and the cellulose nanofibers and be reacted with the hydroxyl groups of the cellulose nanofibers in the absence of a solvent by a method known and used in the art. Specifically, these materials may be heated to about 60° C. to 140° C. with stirring using devices suitable for dispersing, stirring, or mixing, including various kneaders, mixers, mills, homogenizers, dissolvers, grinders, and extruders. Catalysts may also be used in this reaction.

Examples of catalysts include basic catalysts such as pyridine, N,N-dimethylaminopyridine, triethylamine, sodium hydrogen, tert-butyllithium, lithium diisopropylamide, potassium tert-butoxide, sodium methoxide, sodium ethoxide, sodium hydroxide, and sodium acetate.

Although the resin for fibrillation and the unreacted compound and catalyst may remain after the reaction is complete, it is preferred to wash them off because they hinder the formation of pores when a plasticizer is extracted to form pores in the manufacture of a separator, depending on the type of resin for fibrillation. The solvent used for washing is preferably a low-boiling-point solvent, which is very easy to remove. Examples of low-boiling-point solvents include acetone, methanol, ethanol, isopropyl alcohol, and 2-butanone.

The modified cellulose or pulp may be pulverized by a method known and used in the art. Typically, the modified cellulose or pulp can be fibrillated or pulverized in water or an organic solvent by grinding and/or beating using devices such as refiners, high-pressure homogenizers, media-stirring mills, stone mills, grinders, twin-screw extruders, and bead mills. Alternatively, the modified cellulose or pulp can be fibrillated in a resin for fibrillation without using water or an organic solvent. The modified cellulose or pulp can also be fibrillated while being mixed with a matrix resin.

An example method for fibrillating cellulose or pulp in a resin for fibrillation without using water or an organic solvent includes adding cellulose or pulp to a resin for fibrillation and then applying a mechanical shear. The shear can be applied, for example, using known mixers such as bead mills, ultrasonic homogenizers, extruders such as single-screw extruders and twin-screw extruders, Banbury mixers, grinders, pressure kneaders, and two-roll mills. Preferred among these mixers are pressure kneaders, which produce a stable shear even in a viscous resin.

### [Resin for Fibrillation]

The resin for fibrillation in the present invention may be a resin known and used in the art that does not interfere with the advantageous effects of the present invention, for example, the polyester resin (A), the vinyl resin (B), or the modified epoxy resin (C). These resins may be used alone or in a mixture of two or more.

### [Proportion Between Resin for Fibrillation and Modified Cellulose or Pulp]

In the present invention, the resin for fibrillation and the modified cellulose or pulp may be mixed in any proportion.

Although the resin for fibrillation may remain, it is preferred to wash it off because it hinders the formation of pores when a plasticizer is extracted to form pores in the manufacture of a separator, depending on the type of resin for fibrillation. The solvent used for washing is preferably a low-boiling-point solvent, which is very easy to remove. Examples of low-boiling-point solvents include acetone, methanol, ethanol, isopropyl alcohol, and 2-butanone.

The composition according to the present invention may contain suitable additives such as antioxidants.

### [Modified-Cellulose-Nanofiber Containing Polyethylene Fine Porous Film]

The manufacture of the modified-cellulose-nanofiber containing polyethylene fine porous film according to the present invention includes the steps of:

(1) melting and mixing a resin composition containing a polyethylene resin, at least one plasticizer, and modified cellulose nanofibers having alkyl or alkenyl groups with 4 to 30 carbon atoms;

(2) forming the molten mixture prepared in step (1) into a sheet;

(3) stretching the sheet formed in step (2) at least uniaxially at an area ratio of, for example, 4 to less than 100; and

(4) extracting the plasticizer from the sheet stretched in step (3) to form a fine porous film.

Examples of plasticizers used in step (1) include hydrocarbons such as liquid paraffin and paraffin wax; esters such as dibutyl phthalate, di-2-ethylhexyl phthalate, dioctyl sebacate, dioctyl adipate, trioctyl trimellitate, and trioctyl phosphate; and higher alcohols such as oleyl alcohol and stearyl alcohol.

The plasticizer is preferably used in step (1) in such a proportion that melt mixing and sheet forming are possible. Specifically, the proportion of the plasticizer in the resin composition containing a polyethylene resin, at least one plasticizer, and modified cellulose nanofibers having alkyl or alkenyl groups with 4 to 30 carbon atoms is preferably 30% to 80% by mass, more preferably 40% to 70% by mass. A resin composition containing more than 80% plasticizer is not suitable for melt mixing. A resin composition containing less than 30% plasticizer would not form a fine porous film containing a sufficient number of pores.

In step (1), the proportion of the modified cellulose nanofibers is preferably 1% to 30% by mass, more preferably 5% to 30% by mass, of the weight of the resin composition containing a polyethylene resin, at least one plasticizer, and modified cellulose nanofibers having alkyl or alkenyl groups with 4 to 30 carbon atoms excluding the weight of the plasticizer. A resin composition containing less than 1% by mass modified cellulose nanofibers would not form a fine porous film containing modified cellulose nanofibers with improved thermal shrinkage resistance. A resin composition containing more than 30% by mass modified cellulose nanofibers is not suitable for melt mixing or sheet forming.

In step (1), the resin composition containing a polyethylene resin, at least one plasticizer, and modified cellulose nanofibers having alkyl or alkenyl groups with 4 to 30 carbon atoms may be melted and mixed by charging the mixture into a resin mixer such as an extruder or a kneader and mixing the mixture while melting the resin by heating.

Polyolefin resins other than polyethylene and additives such as antioxidants, if added, are preferably added in step (1).

Step (2) is preferably performed by melting the molten mixture of the resin composition containing a polyethylene resin, at least one plasticizer, and modified cellulose nanofibers having alkyl or alkenyl groups with 4 to 30 carbon atoms by heating, extruding the melt into a sheet, for example, through a T-die, and cooling the sheet to a temperature sufficiently lower than the crystallization temperature of the resin.

In step (3), the sheet is heated and stretched by tenter stretching, roll stretching, rolling, or any combination thereof, preferably by simultaneous biaxial stretching using a tenter. The sheet is stretched at a temperature between the crystal dispersion temperature and the crystal melting point of the polyethylene mixture used, preferably 90° C. to 140° C., more preferably 100° C. to 140° C. The possible range of stretch ratios depends on the polyethylene used. Preferably, the sheet is stretched at as high a stretch ratio as possible provided that the sheet does not tear during stretching. A higher stretch ratio is preferred to form a thinner fine porous film.

In step (4), the plasticizer is extracted from the stretched sheet by immersion in an extraction solvent.

The extraction solvent is preferably a solvent in which the plasticizer is highly soluble and in which polyethylene is insoluble. The extraction solvent, which needs to be dried off, preferably has a boiling point lower than the melting point of the polyethylene used, more preferably 100° C. or lower. Examples of such extraction solvents include hydrocarbons such as n-hexane and cyclohexane, halogenated hydrocarbons such as methylene chloride and 1,1,1-trichloroethane, chlorine-free halogenated solvents such as hydrofluoroethers and hydrofluorocarbons, alcohols such as ethanol and isopropanol, ethers such as diethyl ether and tetrahydrofuran, and ketones such as acetone and methyl ethyl ketone.

After the extraction of the plasticizer, the sheet can be further stretched at least uniaxially at least once. This post-extraction stretching may be performed at any stretch ratio, preferably at a ratio of 5 or less for uniaxial stretching or at an area ratio of 20 or less for biaxial stretching. Heat fixing may also be performed within the temperature range between the crystal dispersion temperature and the crystal melting point.

### [Separator and Lithium-Ion Battery]

The modified-cellulose-nanofiber containing polyethylene fine porous film according to the present invention may be directly used as a separator and is particularly suitable for use in lithium-ion batteries.

### EXAMPLES

The present invention is further illustrated by the following examples, although these examples are not intended to limit the present invention. In the examples, units are by mass unless otherwise specified.

### Example Synthesis 1

### Manufacture of Polyester Resin 1

A 2 L glass flask equipped with a nitrogen inlet tube, a reflux condenser, and a stirrer was charged with 758.2 g of diethylene glycol (7.14 mol, charge molar ratio: 0.53), 652.6 g of adipic acid (4.47 mol, charge molar ratio: 0.33), and 183.9 g of maleic anhydride (1.88 mol, charge molar ratio: 0.14), and heating was started under a nitrogen stream. A dehydration condensation reaction was run as usual at an internal temperature of 200° C. When an acid value of 13 mg KOH/g was reached, the mixture was immediately cooled to 150° C., and 2,6-di-tert-butyl-p-cresol was added in an amount of 100 ppm based on the weight of the stock materials. The mixture was further cooled to room temperature to obtain a polyester resin 1 having a hydroxyl value of 89 mg KOH/g.

### [Measurement of Acid Value]

The acid value indicates the weight (mg) of potassium hydroxide required to neutralize 1 g of a polyester resin and is expressed in mg KOH/g.

The acid value was determined by dissolving a polyester resin in tetrahydrofuran and titrating the solution with a 0.1 N solution of potassium hydroxide in methanol.

### [Measurement of Hydroxyl Value]

The hydroxyl value indicates the weight (mg) of the same number of moles of potassium hydroxide as the hydroxyl groups present in 1 g of a polyester resin and is expressed in mg KOH/g.

The hydroxyl value was determined from the area of a peak derived from hydroxyl groups in a 13C-NMR spectrum. Quantitative measurements were performed by gated decoupling 13C-NMR using a JNM-LA300 instrument available from JEOL Ltd. on a 10 wt % solution of a sample in deuterated chloroform containing 10 mg of Cr(acac)3 as a relaxation reagent. The number of acquisitions was 4,000.

### Example Manufacture 1

### Manufacture of Alkenylsuccinic-Anhydride (ASA)-Modified CNF 1

<Preparation of Cellulose Nanofibers using Bead Mill>

A slurry of needle bleached kraft pulp (NBKP) (slurry concentration: 2% by mass) was repeatedly refined to a Canadian Standard freeness of 100 mL or less using a single-disk refiner (available from Kumagai Riki Kogyo Co., Ltd.) to obtain a refined NBKP slurry.

Water was then added to the refined NBKP slurry to a solid content of 0.75%, and 10 kg of the 0.75% refined NBKP slurry was fibrillated in a bead mill available from Aimex Co., Ltd. under the following conditions:

### Fibrillation Conditions

Beads: zirconia beads (diameter: 1 mm)

Vessel capacity: 2 L

Bead charge volume: 1,216 mL (4,612 g)

Rotational speed: 2,000 rpm

Vessel temperature: 20° C.

Discharge rate: 600 mL/min

The resulting CNF slurry was freeze-dried and was examined under a scanning electron microscope for the condition of pulverized cellulose. Most cellulose fibers were fibrillated to less than 100 nm along the minor axis thereof, which demonstrates that the cellulose was finely pulverized.

The resulting slurry was suction-filtered to obtain a CNF slurry having a solid content of 12.5% by mass.

### <Preparation of Alkenylsuccinic-Anhydride (ASA)-Modified CNF>

To 494 g of the CNF slurry having a solid content of 12.5% by mass obtained in Example Manufacture 2 was added 247 g of N-methylpyrrolidone (NMP). The mixture was charged into a TRI-MIX TX-5 mixer (available from Inoue Mfg., Inc.), and stirring was started. The mixture was dehydrated under reduced pressure at 40° C. to 50° C. To the mixture were added 99.1 g of T-NS135 (ASA having 16 carbon atoms other than those from succinic anhydride, available from Seiko PMC Corporation), 2.3 g of dimethylaminopyridine, 10.57 g of potassium carbonate, and 50 g of NMP, and the mixture was reacted at 62° C. for 1.5 hours. After the reaction, the mixture was washed with acetone and then with ethanol and was suction-filtered to obtain an ASA-modified CNF slurry 1 having a solid content of 20.0%. The degree of substitution (DS) of the ASA-modified CNF was 0.40 as measured by back titration.

### Example Manufacture 2

### Manufacture of Mixture 1 of Resin and Cellulose Nanofibers

A pressure kneader available from Moriyama Mfg. Co., Ltd. (DS1-5GHH-H) was charged with 600 g of the polyester resin 1 synthesized in Example Synthesis 1 and 400 g of “KC FLOCK W-50GK”, a cellulose powder product available from Nippon Paper Chemicals Co., Ltd. The cellulose was pulverized by mixing under pressure at 60 rpm for 600 minutes to obtain a mixture 1 of the resin and the cellulose nanofibers. After 0.1 g of the resulting mixture 1 was weighed and suspended in acetone at a concentration of 0.1%, it was dispersed using a T.K. Homo Mixer Type-A mixer available from Tokushu Kikai Kogyo Co., Ltd. at 15,000 rpm for 20 minutes. The resulting dispersion was dried over glass to remove acetone and was examined under a scanning electron microscope for the condition of pulverized cellulose. There were cellulose fibers fibrillated to less than 100 nm along the minor axis thereof, which demonstrates that the cellulose was finely pulverized.

### Example Manufacture 3

### Manufacture of Alkenylsuccinic-Anhydride (ASA)-Modified CNF 2

A 200 mL separable kneader available from Yoshida Seisakusho Co., Ltd. was charged with 60.0 g of the mixture 1 of the resin and the cellulose nanofibers obtained in Example Manufacture 2 and 67.0 g of T-NS135 (ASA having 16 carbon atoms other than those from succinic anhydride, available from Seiko PMC Corporation). The mixture was reacted at a jacket temperature of 130° C. and a rotational speed of 60 rpm for 6 hours to obtain an ASA-modified-cellulose-nanofiber containing masterbatch. The ASA-modified-cellulose-nanofiber containing masterbatch was washed with acetone and was suction-filtered to obtain an ASA-modified CNF slurry 2 having a solid content of 20.0%. The ASA-modified CNF slurry was dried to obtain dry ASA-modified cellulose nanofibers. The degree of substitution (DS) of the ASA-modified cellulose nanofibers was 0.25 as measured by back titration.

### Example Manufacture 4

### Manufacture of Succinic-Anhydride-Modified CNF

A 200 mL separable kneader available from Yoshida Seisakusho Co., Ltd. was charged with 70.8 g of the mixture 1 of the resin and the cellulose nanofibers obtained in Example Manufacture 2 and 59.2 g of succinic anhydride (extra-pure reagent available from Kanto Chemical Co., Inc.). The mixture was reacted at a jacket temperature of 100° C. and a rotational speed of 60 rpm for 6 hours to obtain a succinic-anhydride-modified-cellulose-nanofiber containing masterbatch. The succinic-anhydride-modified-cellulose-nanofiber containing masterbatch was washed with acetone and was suction-filtered to obtain a succinic-anhydride-modified CNF slurry having a solid content of 20.0%. The succinic-anhydride-modified CNF slurry was dried to obtain dry succinic-anhydride-modified cellulose nanofibers. The degree of substitution (DS) of the succinic-anhydride-modified cellulose nanofibers was 0.35 as measured by back titration.

### Example 1

### Manufacture of ASA-Modified CNF Composite Fine Porous Film

A mixture was prepared from 269.5 g of the ASA-modified CNF slurry 1 with a solid content of 20.0% obtained in Example Manufacture 1, 46.1 g of polyethylene (FLO-BEADS HE3040 available from Sumitomo Seika Chemicals Co., Ltd.), and 684.4 g of ethanol. After thorough stirring, the mixture was suction-filtered to obtain an ASA-modified CNF/polyethylene mixture slurry having a solid content of 20%. A 2 L glass flask equipped with a stirrer was charged with 200 g of the ASA-modified CNF/polyethylene mixture slurry having a solid content of 20%. The flask was immersed in an oil bath at 80° C., and the solvent was removed under reduced pressure with stirring to obtain an ASA-modified CNF/polyethylene mixture 1. A mixture was then prepared from 16.0 g of the ASA-modified CNF/polyethylene mixture 1 and 32.0 g of polyethylene (HI-ZEX 5000S available from Prime Polymer Co., Ltd.) and was mixed under heating in a Labo Plastomill mixer available from Toyo Seiki Seisaku-Sho, Ltd. The mixture was mixed under heating at a heating temperature of 180° C. and a rotational speed of 100 rpm for 5 minutes. The molten mixture was removed and cooled. The resulting solid was held between metal plates with polyimide films therebetween and was compressed at 10 MPa using a heat press at 180° C. to form an ASA-modified CNF composite polyethylene sheet 1 having a thickness of about 500 μm. This sheet was cut into about 5 mm square pieces.

A mixture was then prepared from 19.0 g of the about 5 mm square pieces of the ASA-modified CNF composite polyethylene sheet 1, 1.0 g of polyethylene (FLO-BEADS HE3040 available from Sumitomo Seika Chemicals Co., Ltd.), 15.0 g of di-2-ethylhexyl phthalate (available from Kanto Chemical Co., Inc.), and 15.0 g of liquid paraffin (available from Kanto Chemical Co., Inc.) and was mixed under heating in a Labo Plastomill mixer available from Toyo Seiki Seisaku-Sho, Ltd. The mixture was mixed under heating at a heating temperature of 200° C. and a rotational speed of 50 rpm for 10 minutes. The molten mixture was removed and cooled. The resulting solid was held between metal plates with polyimide films therebetween and was compressed at 10 MPa using a heat press at 200° C. to form a sheet having an average thickness of 290 μm. This sheet was cut to a size of 9.5 cm square and was biaxially stretched at a ratio of 2 in the longitudinal direction and a ratio of 2 in the transverse direction at 120° C. using a biaxial stretching tester available from Toyo Seiki Seisaku-Sho, Ltd. The stretched film was immersed in methylene chloride to extract the di-2-ethylhexyl phthalate and the liquid paraffin. The sheet was then dried at room temperature to obtain an ASA-modified CNF composite polyethylene fine porous film 1. The ASA-modified CNF composite polyethylene fine porous film 1 had an average thickness of 55 μm.

### Example 2

A mixture was prepared from 224.6 g of the ASA-modified CNF slurry 2 with a solid content of 20.0% obtained in Example Manufacture 3, 55.1 g of polyethylene (FLO-BEADS HE3040 available from Sumitomo Seika Chemicals Co., Ltd.), and 722.6 g of acetone. After thorough stirring, the mixture was suction-filtered to obtain an ASA-modified CNF/polyethylene mixture slurry having a solid content of 20%. A 2 L glass flask equipped with a stirrer was charged with 200 g of the ASA-modified CNF/polyethylene mixture slurry having a solid content of 20%. The flask was immersed in an oil bath at 80° C., and the solvent was removed under reduced pressure with stirring to obtain an ASA-modified CNF/polyethylene mixture 2. A mixture was then prepared from 16.0 g of the ASA-modified CNF/polyethylene mixture 2 and 32.0 g of polyethylene (HI-ZEX 5000S available from Prime Polymer Co., Ltd.) and was mixed under heating in a Labo Plastomill mixer available from Toyo Seiki Seisaku-Sho, Ltd. The mixture was mixed under heating at a heating temperature of 180° C. and a rotational speed of 100 rpm for 5 minutes. The molten mixture was removed and cooled. The resulting solid was held between metal plates with polyimide films therebetween and was compressed at 10 MPa using a heat press at 180° C. to form an ASA-modified CNF composite polyethylene sheet 2 having a thickness of about 500 μm. This sheet was cut into about 5 mm square pieces.

A mixture was then prepared from 19.0 g of the about 5 mm square pieces of the ASA-modified CNF composite polyethylene sheet 2, 1.0 g of polyethylene (FLO-BEADS HE3040 available from Sumitomo Seika Chemicals Co., Ltd.), 15.0 g of di-2-ethylhexyl phthalate (available from Kanto Chemical Co., Inc.), and 15.0 g of liquid paraffin (available from Kanto Chemical Co., Inc.) and was mixed under heating in a Labo Plastomill mixer available from Toyo Seiki Seisaku-Sho, Ltd. The mixture was mixed under heating at a heating temperature of 200° C. and a rotational speed of 50 rpm for 10 minutes. The molten mixture was removed and cooled. The resulting solid was held between metal plates with polyimide films therebetween and was compressed at 10 MPa using a heat press at 200° C. to form a sheet having an average thickness of 290 μm. This sheet was cut to a size of 9.5 cm square and was biaxially stretched at a ratio of 2 in the longitudinal direction and a ratio of 2 in the transverse direction at 120° C. using a biaxial stretching tester available from Toyo Seiki Seisaku-Sho, Ltd. The stretched film was immersed in methylene chloride to extract the di-2-ethylhexyl phthalate and the liquid paraffin. The sheet was then dried at room temperature to obtain an ASA-modified CNF composite polyethylene fine porous film 2. The ASA-modified CNF composite polyethylene fine porous film 2 had an average thickness of 55 μm.

### Comparative Example 1

A mixture was prepared from 3.9 g of polyethylene (FLO-BEADS HE3040 available from Sumitomo Seika Chemicals Co., Ltd.), 16.1 g of polyethylene (HI-ZEX 5000S available from Prime Polymer Co., Ltd.), 15.0 g of di-2-ethylhexyl phthalate (available from Kanto Chemical Co., Inc.), and 15.0 g of liquid paraffin (available from Kanto Chemical Co., Inc.) and was mixed under heating in a Labo Plastomill mixer available from Toyo Seiki Seisaku-Sho, Ltd. The mixture was mixed under heating at a heating temperature of 200° C. and a rotational speed of 50 rpm for 10 minutes. The molten mixture was removed and cooled. The resulting solid was held between metal plates with polyimide films therebetween and was compressed at 10 MPa using a heat press at 200° C. to form a sheet having an average thickness of 286 μm. This sheet was cut to a size of 10 cm square and was biaxially stretched at a ratio of 2 in the longitudinal direction and a ratio of 2 in the transverse direction at 120° C. using a biaxial stretching tester available from Toyo Seiki Seisaku-Sho, Ltd. The stretched film was immersed in methylene chloride to extract the di-2-ethylhexyl phthalate and the liquid paraffin. The sheet was then dried at room temperature to obtain a polyethylene fine porous film. The polyethylene fine porous film had an average thickness of 60 μm.

### Comparative Example 2

To 100 g of cellulose nanofibers, i.e., “CELISH KY-100G” available from Daicel FineChem Ltd., was added 100 g of ethanol. After stirring, the mixture was suction-filtered. Ethanol was then added to the resulting wet cake of cellulose nanofibers to a solid content of 5%. A 2 L glass flask equipped with a stirrer was charged with 600 g of the slurry of the cellulose nanofibers in ethanol (solid content: 5%) and 70.0 g of polyethylene (FLO-BEADS HE3040 available from Sumitomo Seika Chemicals Co., Ltd.). The flask was immersed in an oil bath at 80° C., and the solvent was removed under reduced pressure with stirring to obtain a CNF/polyethylene mixture 1. A mixture was then prepared from 16.0 g of the CNF/polyethylene mixture 1 and 32.0 g of polyethylene (HI-ZEX 5000S available from Prime Polymer Co., Ltd.) and was mixed under heating in a Labo Plastomill mixer available from Toyo Seiki Seisaku-Sho, Ltd. The mixture was mixed under heating at a heating temperature of 180° C. and a rotational speed of 100 rpm for 5 minutes. The molten mixture was removed and cooled. The resulting solid was held between metal plates with polyimide films therebetween and was compressed at 10 MPa using a heat press at 180° C. to form an ASA-modified CNF composite polyethylene sheet having a thickness of about 500 μm. This sheet was cut into about 5 mm square pieces.

A mixture was then prepared from 19.0 g of the about 5 mm square pieces of the CNF composite polyethylene sheet, 1.0 g of polyethylene (FLO-BEADS HE3040 available from Sumitomo Seika Chemicals Co., Ltd.), 15.0 g of di-2-ethylhexyl phthalate (available from Kanto Chemical Co., Inc.), and 15.0 g of liquid paraffin (available from Kanto Chemical Co., Inc.) and was mixed under heating in a Labo Plastomill mixer available from Toyo Seiki Seisaku-Sho, Ltd. The mixture was mixed under heating at a heating temperature of 200° C. and a rotational speed of 50 rpm for 10 minutes. The molten mixture was removed and cooled. The resulting solid was held between metal plates with polyimide films therebetween and was compressed at 10 MPa using a heat press at 200° C. to form a sheet having an average thickness of 290 μm. This sheet was cut to a size of 9.5 cm square and was biaxially stretched at a ratio of 2 in the longitudinal direction and a ratio of 2 in the transverse direction at 120° C. using a biaxial stretching tester available from Toyo Seiki Seisaku-Sho, Ltd. The stretched film was immersed in methylene chloride to extract the di-2-ethylhexyl phthalate and the liquid paraffin. The sheet was then dried at room temperature to obtain a CNF composite polyethylene fine porous film. The CNF composite polyethylene fine porous film had an average thickness of 50 μm.

### Comparative Example 3

### Manufacture of CNF Composite Fine Porous Film

A mixture was prepared from 12.5 g of the mixture of the resin and the cellulose nanofibers obtained in Example Manufacture 2 and 37.5 g of polyethylene (HI-ZEX 5000S available from Prime Polymer Co., Ltd.) and was mixed under heating in a Labo Plastomill mixer available from Toyo Seiki Seisaku-Sho, Ltd. The mixture was mixed under heating at a heating temperature of 180° C. and a rotational speed of 100 rpm for 5 minutes. The molten mixture was removed and cooled. The resulting solid was held between metal plates with polyimide films therebetween and was compressed at 10 MPa using a heat press at 180° C. to form a CNF composite polyethylene sheet having a thickness of about 500 μm. This sheet was cut into about 5 mm square pieces.

A mixture was then prepared from 19.0 g of the about 5 mm square pieces of the CNF composite polyethylene sheet, 3.4 g of polyethylene (FLO-BEADS HE3040 available from Sumitomo Seika Chemicals Co., Ltd.), 0.4 g of polyethylene (HI-ZEX 5000S available from Prime Polymer Co., Ltd.), 12.2 g of di-2-ethylhexyl phthalate (available from Kanto Chemical Co., Inc.), and 15.0 g of liquid paraffin (available from Kanto Chemical Co., Inc.) and was mixed under heating in a Labo Plastomill mixer available from Toyo Seiki Seisaku-Sho, Ltd. The mixture was mixed under heating at a heating temperature of 200° C. and a rotational speed of 50 rpm for 10 minutes. The molten mixture was removed and cooled. The resulting solid was held between metal plates with polyimide films therebetween and was compressed at 10 MPa using a heat press at 200° C. to form a sheet having an average thickness of 290 μm. This sheet was cut to a size of 9.5 cm square and was biaxially stretched at a ratio of 2 in the longitudinal direction and a ratio of 2 in the transverse direction at 120° C. using a biaxial stretching tester available from Toyo Seiki Seisaku-Sho, Ltd. The stretched film was immersed in methylene chloride to extract the polyester resin 1, the di-2-ethylhexyl phthalate, and the liquid paraffin. The sheet was then dried at room temperature to obtain a CNF composite polyethylene fine porous film. The CNF composite polyethylene fine porous film had an average thickness of 50 μm.

### Comparative Example 4

A mixture was prepared from 182.4 g of the succinic-anhydride-modified CNF slurry with a solid content of 20.0% obtained in Example Manufacture 4, 63.5 g of polyethylene (FLO-BEADS HE3040 available from Sumitomo Seika Chemicals Co., Ltd.), and 754.1 g of acetone. After thorough stirring, the mixture was suction-filtered to obtain a succinic-anhydride-modified CNF/polyethylene mixture slurry having a solid content of 20%. A 2 L glass flask equipped with a stirrer was charged with 200 g of the succinic-anhydride-modified CNF/polyethylene mixture slurry having a solid content of 20%. The flask was immersed in an oil bath at 80° C., and the solvent was removed under reduced pressure with stirring to obtain a succinic-anhydride-modified CNF/polyethylene mixture. A mixture was then prepared from 16.0 g of the succinic-anhydride-modified CNF/polyethylene mixture and 32.0 g of polyethylene (HI-ZEX 5000S available from Prime Polymer Co., Ltd.) and was mixed under heating in a Labo Plastomill mixer available from Toyo Seiki Seisaku-Sho, Ltd. The mixture was mixed under heating at a heating temperature of 180° C. and a rotational speed of 100 rpm for 5 minutes. The molten mixture was removed and cooled. The resulting solid was held between metal plates with polyimide films therebetween and was compressed at 10 MPa using a heat press at 180° C. to form a succinic-anhydride-modified CNF composite polyethylene sheet having a thickness of about 500 μm. This sheet was cut into about 5 mm square pieces.

A mixture was then prepared from 19.0 g of the about 5 mm square pieces of the ASA-modified CNF composite polyethylene sheet, 1.0 g of polyethylene (FLO-BEADS HE3040 available from Sumitomo Seika Chemicals Co., Ltd.), 15.0 g of di-2-ethylhexyl phthalate (available from Kanto Chemical Co., Inc.), and 15.0 g of liquid paraffin (available from Kanto Chemical Co., Inc.) and was mixed under heating in a Labo Plastomill mixer available from Toyo Seiki Seisaku-Sho, Ltd. The mixture was mixed under heating at a heating temperature of 200° C. and a rotational speed of 50 rpm for 10 minutes. The molten mixture was removed and cooled. The resulting solid was held between metal plates with polyimide films therebetween and was compressed at 10 MPa using a heat press at 200° C. to form a sheet having an average thickness of 290 μm. This sheet was cut to a size of 9.5 cm square and was biaxially stretched at a ratio of 2 in the longitudinal direction and a ratio of 2 in the transverse direction at 120° C. using a biaxial stretching tester available from Toyo Seiki Seisaku-Sho, Ltd. The stretched film was immersed in methylene chloride to extract the di-2-ethylhexyl phthalate and the liquid paraffin. The sheet was then dried at room temperature to obtain a succinic-anhydride-modified CNF composite polyethylene fine porous film. The succinic-anhydride-modified CNF composite polyethylene fine porous film had an average thickness of 50 μm.

### Examination for Open Pores

Each fine porous film was examined for open pores under a scanning electron microscope at magnifications of 10,000× and 30,000×.

### Closed Pore Test (Shutdown Test)

Each fine porous film was cut to a size of 1 cm×5 cm, was placed on a glass plate, and was fixed at one short side thereof with a heat-resistant tape. The fine porous film was heated in an oven at 120° C. for 30 minutes. After cooling, the fine porous film was examined for closed pores under a scanning electron microscope at a magnification of 30,000×.

### Shrinkage

Each fine porous film was cut to a size of 1 cm×5 cm, was placed on a glass plate, and was fixed at one short side thereof with a heat-resistant tape. The fine porous film was heated in an oven at 120° C., 130° C., 140° C., and 150° C. for 30 minutes. After cooling, the shrinkage of the fine porous film was measured along the long sides thereof. A shrinkage of less than 5% was rated as excellent. A shrinkage of 5% to less than 10% was rated as good. A shrinkage of 10% to less than 15% was rated as fair. A shrinkage of 15% or more was rated as poor.

TABLE 1

| | | Closed | | | | |
|---|---|---|---|---|---|---|
| | | pore | | | | |
| | Open | test | Shrinkage | | | |
| | pores | 120° C. | 120° C. | 130° C. | 140° C. | 150° C. |
| Example 1 | Good | Good | Excellent | Excellent | Good | Good |
| Example 2 | Good | Good | Excellent | Excellent | Good | Good |
| Comparative | Good | Good | Fair | Poor | Poor | Poor |
| Example 1 | | | | | | |
| Comparative | Good | Good | Good | Fair | Poor | Poor |
| Example 2 | | | | | | |
| Comparative | Good | Good | Excellent | Good | Fair | Poor |
| Example 3 | | | | | | |
| Comparative | Good | Good | Excellent | Good | Fair | Poor |
| Example 4 | | | | | | |

### INDUSTRIAL APPLICABILITY

A fine porous film according to the present invention has good heat resistance and a shutdown function and is therefore suitable for use as a separator in lithium-ion batteries.

1. A modified-cellulose-nanofiber containing polyethylene fine porous film comprising modified cellulose nanofibers having alkyl or alkenyl groups with 4 to 30 carbon atoms.

2. The modified-cellulose-nanofiber containing polyethylene fine porous film according to claim 1, wherein the modified cellulose nanofibers are modified cellulose nanofibers prepared by fibrillating cellulose into cellulose nanofibers in a nonaqueous resin and modifying the cellulose nanofibers.

3. The modified-cellulose-nanofiber containing polyethylene fine porous film according to claim 1, wherein the modified cellulose nanofibers are modified cellulose nanofibers prepared by fibrillating modified cellulose or pulp in a nonaqueous resin.

4. The modified-cellulose-nanofiber containing polyethylene fine porous film according to claim 1, wherein the modified-cellulose-nanofiber containing polyethylene fine porous film is a separator.

5. A lithium-ion battery comprising the separator according to claim 4.

6. The modified-cellulose-nanofiber containing polyethylene fine porous film according to claim 2, wherein the modified-cellulose-nanofiber containing polyethylene fine porous film is a separator.

7. The modified-cellulose-nanofiber containing polyethylene fine porous film according to claim 3, wherein the modified-cellulose-nanofiber containing polyethylene fine porous film is a separator.

8. A lithium-ion battery comprising the separator according to claim 6.

9. A lithium-ion battery comprising the separator according to claim 7.
